(19) United States
(12) Patent Application Publication
(10) Pub. No.: US 2026/0205621 A1
(43) Pub. Date: Jul. 16, 2026

(54) BITSTREAM CONFORMANCE CONDITIONS RELATED TO MESHPATCHES IN V-DMC

(71) Applicant: Samsung Electronics Co., Ltd., Suwon-si (KR)

(72) Inventors: Rajan Laxman Joshi, San Diego, CA (US); Madhukar Budagavi, Plano, TX (US)

(21) Appl. No.: 19/449,322

(22) Filed: Jan. 14, 2026

Related U.S. Application Data
(60) Provisional application No. 63/745,712, filed on Jan. 15, 2025.
(60) Provisional application No. 63/747,683, filed on Jan. 21, 2025.
(60) Provisional application No. 63/754,426, filed on Feb. 5, 2025.

(51) Int. Cl. H04N 19/54; H04N 19/53; H04N 19/597; H04N 19/70

(52) U.S. Cl. CPC H04N 19/54; H04N 19/53; H04N 19/597; H04N 19/70

(57) ABSTRACT

A method includes encoding geometry data and attributes data associated with at least one submesh into a displacement sub-bitstream and an attributes sub-bitstream. The method also includes establishing at least one one-to-one correspondence between the at least one submesh and at least one meshpatch based on one or more bitstream conformance conditions. The one or more bitstream conformance conditions are configured to prevent an overlap of at least two bounding boxes based on the geometry data. The method also includes combining the displacement sub-bitstream and the attributes sub-bitstream into a compressed bitstream.

### CROSS-REFERENCE TO RELATED APPLICATION AND PRIORITY CLAIM

This application claims priority under 35 U.S.C. § 119(e) to U.S. Provisional Patent Application No. 63/745,712 filed on Jan. 15, 2025, U.S. Provisional Patent Application No. 63/747,683 filed on Jan. 21, 2025, and U.S. Provisional Patent Application No. 63/754,426 filed on Feb. 5, 2025, which are hereby incorporated by reference in their entirety.

### TECHNICAL FIELD

This disclosure relates generally to multimedia devices and processes. More specifically, this disclosure relates to bitstream conformance conditions related to meshpatches in video-based dynamic mesh coding (V-DMC).

### BACKGROUND

Three hundred sixty degree (360°) video and three dimensional (3D) volumetric video are emerging as new ways of experiencing immersive content due to the ready availability of powerful handheld devices such as smartphones. While 360° video enables an immersive “real life,” “being-there,” experience for consumers by capturing the 360° outside-in view of the world, 3D volumetric video can provide a complete six degrees of freedom (DoF) experience of being immersed and moving within the content. Users can interactively change their viewpoint and dynamically view any part of the captured scene or object they desire. Display and navigation sensors can track head movement of a user in real-time to determine the region of the 360° video or volumetric content that the user wants to view or interact with. Multimedia data that is 3D in nature, such as point clouds or 3D polygonal meshes, can be used in the immersive environment. This data can be stored in a video format and encoded and compressed for transmission as a bitstream to other devices.

### SUMMARY

This disclosure provides for bitstream conformance conditions related to meshpatches in V-DMC.

In a first embodiment, a method includes encoding geometry data and attributes data associated with at least one submesh into a displacement sub-bitstream and an attributes sub-bitstream. The method also includes establishing at least one one-to-one correspondence between the at least one submesh and at least one meshpatch based on one or more bitstream conformance conditions. The one or more bitstream conformance conditions are configured to prevent an overlap of at least two bounding boxes based on the geometry data. The method also includes combining the displacement sub-bitstream and the attributes sub-bitstream into a compressed bitstream.

In a second embodiment, an apparatus includes a communication interface and a processor operably coupled to the communication interface. The processor is configured to encode geometry data and attributes data associated with at least one submesh into a displacement sub-bitstream and an attributes sub-bitstream. The processor is also configured to establish at least one one-to-one correspondence between the at least one submesh and at least one meshpatch based on one or more bitstream conformance conditions, wherein the one or more bitstream conformance conditions are configured to prevent an overlap of at least two bounding boxes based on the geometry data. The processor is also configured to combine the displacement sub-bitstream and the attributes sub-bitstream into a compressed bitstream.

In a third embodiment, an apparatus includes a communication interface configured to receive a compressed bitstream having sub-bitstreams including a base mesh sub-bitstream, a displacement sub-bitstream, and an attributes sub-bitstream. The apparatus also includes a processor operably coupled to the communication interface. The processor is configured to decode at least a portion of the compressed bitstream, wherein the processor is configured to decode at least one submesh and at least one meshpatch from the base mesh sub-bitstream, decode geometry data from the displacement sub-bitstream, and decode attributes data from the attributes sub-bitstream based on one or more bitstream conformance conditions. The processor is also configured to reconstruct vertex positions, using the decoded geometry data, and attributes, using the decoded attributes data, based on the one or more bitstream conformance conditions to prevent an overlap of at least two bounding boxes based on the geometry data and. The processor is also configured to reconstruct at least a portion of a mesh-frame using the reconstructed vertex positions and reconstructed attributes corresponding to the subdivided submesh.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with this disclosure;

FIGS. 2 and 3 illustrate example electronic devices in accordance with this disclosure;

FIG. 4A illustrates an example mesh frame encoding process in accordance with this disclosure;

FIG. 4B illustrates an example mesh frame decoding process in accordance with this disclosure;

FIG. 5 illustrates an example process for using bitstream conformance conditions related to meshpatches in V-DMC in accordance with this disclosure;

FIG. 6 illustrates an example encoding method using bitstream conformance conditions related to meshpatches in V-DMC in accordance with this disclosure; and

FIG. 7 illustrates an example decoding method using bitstream conformance conditions related to meshpatches in V-DMC in accordance with this disclosure.

### DETAILED DESCRIPTION

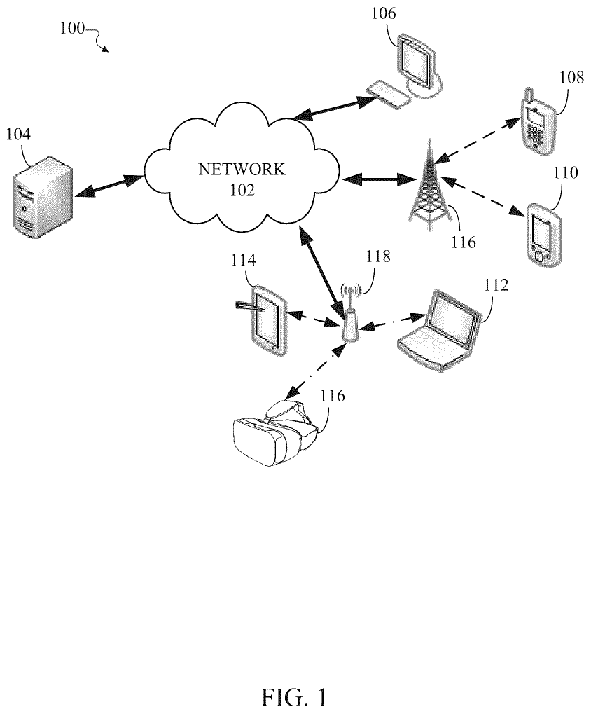

FIGS. 1 through 7, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

As noted above, three hundred sixty degree (360°) video and three dimensional (3D) volumetric video are emerging as new ways of experiencing immersive content due to the ready availability of powerful handheld devices such as smartphones. While 360° video enables an immersive “real life,” “being-there,” experience for consumers by capturing the 360° outside-in view of the world, 3D volumetric video can provide a complete six degrees of freedom (DoF) experience of being immersed and moving within the content. Users can interactively change their viewpoint and dynamically view any part of the captured scene or object they desire. Display and navigation sensors can track head movement of a user in real-time to determine the region of the 360° video or volumetric content that the user wants to view or interact with. Multimedia data that is 3D in nature, such as point clouds or 3D polygonal meshes, can be used in the immersive environment. This data can be stored in a video format and encoded and compressed for transmission as a bitstream to other devices.

A point cloud is a set of 3D points along with attributes such as color, normal directions, reflectivity, point-size, etc. that represent an object's surface or volume. Point clouds are common in a variety of applications such as gaming, 3D maps, visualizations, medical applications, augmented reality, virtual reality, autonomous driving, multi-view replay, and six degrees of freedom (DoF) immersive media, to name a few. Point clouds, if uncompressed, generally utilizes a large amount of bandwidth for transmission. Due to the large bitrate requirement, point clouds are often compressed prior to transmission. Compressing a 3D object, such as a point cloud, often requires specialized hardware. To avoid specialized hardware to compress a 3D point cloud, a 3D point cloud can be transformed into two-dimensional (2D) frames and that can be compressed and later reconstructed and viewable to a user.

Polygonal 3D meshes, especially triangular meshes, are another popular format for representing 3D objects. Meshes can typically include a set of vertices, edges and faces that are used for representing the surface of 3D objects. Triangular meshes are simple polygonal meshes in which the faces are simple triangles covering the surface of the 3D object. Typically, there may be one or more attributes associated with the mesh. In one scenario, one or more attributes may be associated with each vertex in the mesh. For example, a texture attribute (RGB) may be associated with each vertex. In another scenario, each vertex may be associated with a pair of coordinates, (u, v). The (u, v) coordinates may point to a position in a texture map associated with the mesh. For example, the (u, v) coordinates may refer to row and column indices in the texture map, respectively. A mesh can be thought of as a point cloud with additional connectivity information.

The point cloud or meshes may be dynamic, i.e., they may vary with time. In these cases, the point cloud or mesh at a particular time instant may be referred to as a point cloud frame or a mesh frame, respectively. Since point clouds and meshes contain a large amount of data, they utilize compression for efficient storage and transmission. This is particularly true for dynamic point clouds and meshes, which may contain 60 frames or higher per second.

Some bitstream compression (such as V-DMC) utilizes a one-to-one correspondence such that each submesh is associated with a single mesh patch of a given type, whether geometry or attribute, and a single level-of-detail index. However, the Draft International Standard (DIS) version of the V-DMC specification (MDS24469_WG07_N01027) does not prohibit multiple geometry mesh patches with the same submesh index (mdu_submesh_idx) and the same level-of-detail index, and the same gap exists for attribute mesh patches.

Additionally, the bounding boxes that reference regions in the geometry video corresponding to geometry mesh patches should not overlap to enable parallel processing of displacements associated with submeshes and prevent loss of displacement data caused by overlap. However, the DIS version of the V-DMC specification does not require non-overlapping bounding boxes. Further, the number of submeshes is signaled with two syntax elements, although a single element would suffice, increasing computation cost.

This disclosure provides for bitstream conformance conditions between geometry meshpatches to prevent overlap and loss of displacement data. Various embodiments of this disclosure include bitstream conformance conditions on bitstreams and syntax elements to facilitate one-to-one correspondence of submeshes during decoding or reconstruction of vertices and corresponding attributes for the submeshes. As further described in this disclosure, in some embodiments, a bitstream conformance can be imposed that requires that two different geometry meshpatches that have the same LOD index cannot have the same submesh ID. As further described in this disclosure, in some embodiments, a bitstream conformance can be imposed that requires that two different attribute meshpatches cannot have the same submesh ID.

In some instance in this disclosure, the term “submesh” can refer to the partitioning of the base mesh. In some instances, in this disclosure, “submesh” can mean the geometric data that is reconstructed after the submesh is subdivided and displacements added.

FIG. 1 illustrates an example communication system 100 in accordance with this disclosure. The embodiment of the communication system 100 shown in FIG. 1 is for illustration only. Other embodiments of the communication system 100 can be used without departing from the scope of this disclosure.

As shown in FIG. 1, the communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a TV, an interactive display, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-116. In certain embodiments, each server 104 can include an encoder. In certain embodiments, the server 104 can perform encoding, decoding, and reconstruction of submeshes as described in this disclosure.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and an HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. The HMD 116 can display 360° scenes including one or more dynamic or static 3D point clouds. In certain embodiments, any of the client devices 106-116 can include an encoder, decoder, or both. For example, the mobile device 108 can record a 3D volumetric video and then encode the video enabling the video to be transmitted to one of the client devices 106-116. In another example, the laptop computer 112 can be used to generate a 3D point cloud or mesh, which is then encoded and transmitted to one of the client devices 106-116.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can be used to compress a point cloud or mesh, generate a bitstream that represents the point cloud or mesh, and transmit the bitstream to another client device such as any client device 106-116.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

In certain embodiments, any of the client devices 106-116 or the server 104 can create a 3D point cloud or mesh, compress a 3D point cloud or mesh, transmit a 3D point cloud or mesh, receive a 3D point cloud or mesh, decode a 3D point cloud or mesh, render a 3D point cloud or mesh, or a combination thereof. For example, the server 104 can compress a 3D point cloud or mesh to generate a bitstream and then transmit the bitstream to one or more of the client devices 106-116. As another example, one of the client devices 106-116 can compress a 3D point cloud or mesh to generate a bitstream and then transmit the bitstream to another one of the client devices 106-116 or to the server 104. In accordance with this disclosure, the server 104 or the client devices 106-116 can perform encoding, decoding, and reconstruction of submeshes as described in this disclosure.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

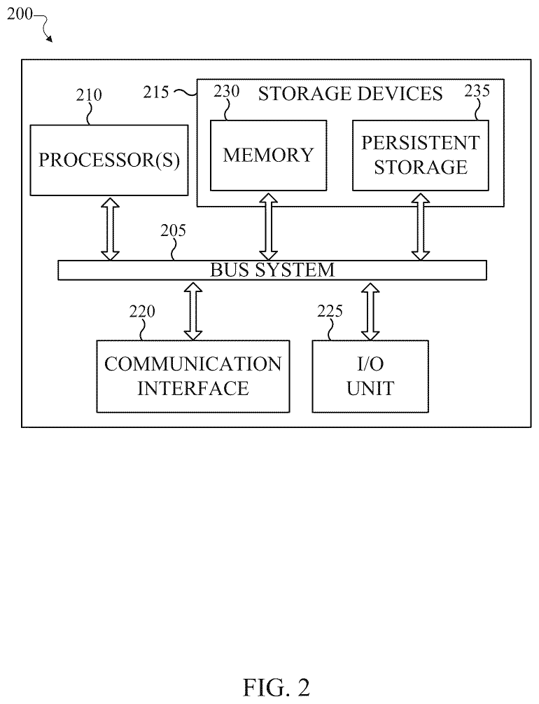

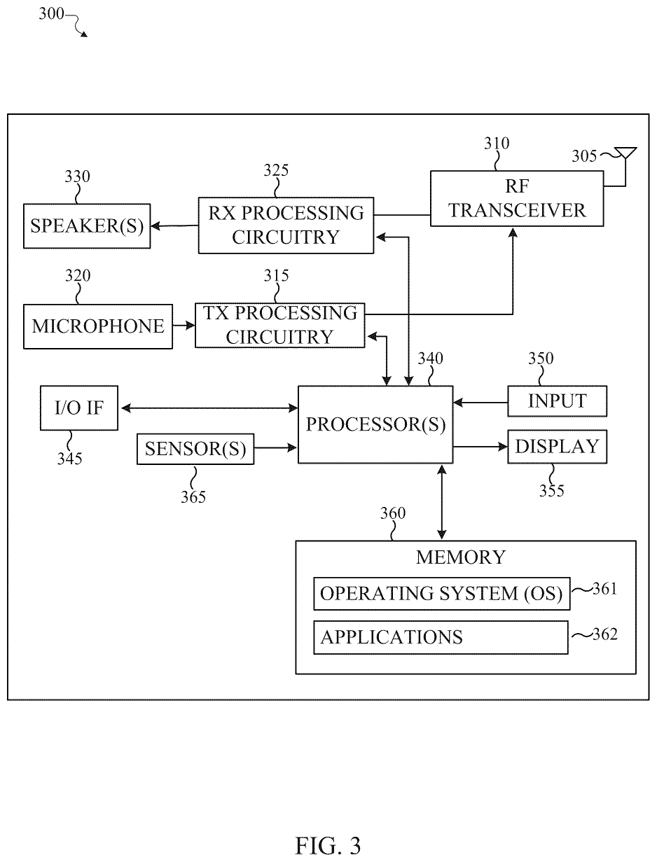

FIGS. 2 and 3 illustrate example electronic devices in accordance with this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 can represent one or more local servers, one or more compression servers, or one or more encoding servers, such as an encoder. In certain embodiments, the encoder can perform decoding. As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

In certain embodiments, the processor 210 can encode a 3D point cloud or mesh stored within the storage devices 215. In certain embodiments, encoding a 3D point cloud also decodes the 3D point cloud or mesh to ensure that when the point cloud or mesh is reconstructed, the reconstructed 3D point cloud or mesh matches the 3D point cloud or mesh prior to the encoding. In certain embodiments, the processor 210 can perform encoding, decoding, and reconstruction of submeshes as described in this disclosure.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for decomposing a point cloud into patches, instructions for packing the patches on 2D frames, instructions for compressing the 2D frames, as well as instructions for encoding 2D frames in a certain order in order to generate a bitstream. The instructions stored in the memory 230 can also include instructions for rendering the point cloud on an omnidirectional 360° scene, as viewed through a VR headset, such as HMD 116 of FIG. 1. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content. In certain embodiments, the processor 340 can perform encoding, decoding, and reconstruction of submeshes as described in this disclosure.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text or graphics, such as from websites, videos, games, images, and the like. The display 355 can be sized to fit within an HMD. The display 355 can be a singular display screen or multiple display screens capable of creating a stereoscopic display. In certain embodiments, the display 355 is a heads-up display (HUD). The display 355 can display 3D objects, such as a 3D point cloud or mesh.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, meshes, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

As discussed in greater detail below, one or more of these sensor(s) 365 may be used to control a user interface (UI), detect UI inputs, determine the orientation and facing the direction of the user for three-dimensional content display identification, and the like. Any of these sensor(s) 365 may be located within the electronic device 300, within a secondary device operably connected to the electronic device 300, within a headset configured to hold the electronic device 300, or in a singular device where the electronic device 300 includes a headset.

The electronic device 300 can create media content such as generate a virtual object or capture (or record) content through a camera. The electronic device 300 can encode the media content to generate a bitstream, such that the bitstream can be transmitted directly to another electronic device or indirectly such as through the network 102 of FIG. 1. The electronic device 300 can receive a bitstream directly from another electronic device or indirectly such as through the network 102 of FIG. 1.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

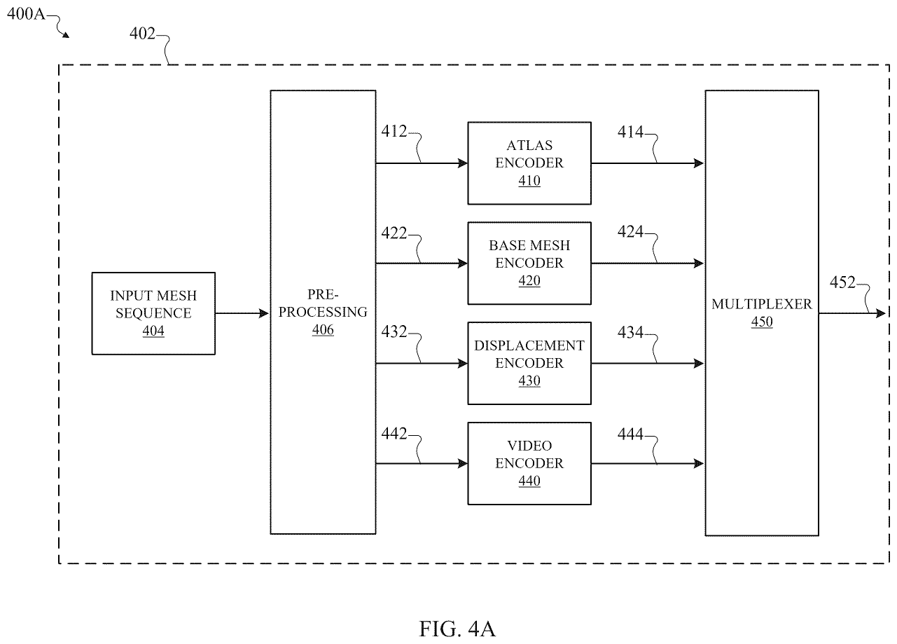

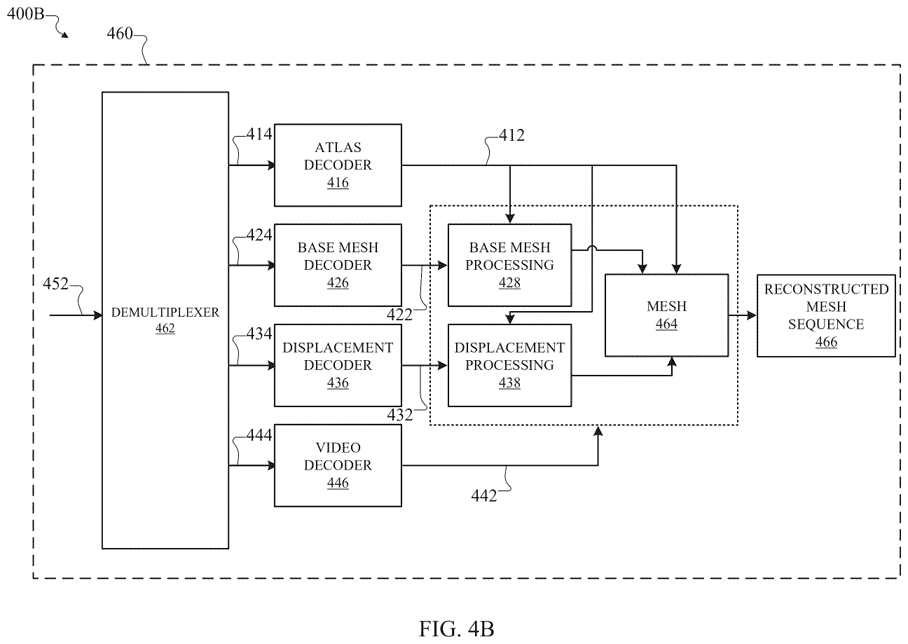

FIG. 4A illustrates an example mesh frame encoding process 400A in accordance with this disclosure. The mesh frame encoding process 400A illustrated in FIG. 4A is for illustration only. FIG. 4A does not limit the scope of this disclosure to any particular implementation of a mesh frame encoding process. For ease of explanation, the mesh frame encoding process 400A of FIG. 4A may be described as being performed using the electronic device 300 of FIG. 3. However, the mesh frame encoding process 400A may be used with any other suitable system and any other suitable electronic device.

As shown in FIG. 4A, the mesh frame encoding process 400A encodes a mesh frame using a mesh frame encoder 402, such as a V-DMC encoder. For example, the 402 may receive an input dynamic mesh sequence 404. The mesh frame encoder 402 can be represented by, or executed by, the server 200 shown in FIG. 2 or the electronic device 300 shown in FIG. 3.

The mesh frame encoder 402 may receive the input dynamic mesh sequence 404 at a pre-processing portion 406, where the input dynamic mesh sequence 404 may be separated into different parts. For example, the input dynamic mesh sequence 404 may be used to generate an atlas 412, a base mesh 422, a displacement data 432, and an attribute data 442. The atlas 412 may be encoded using an atlas encoder 410, the base mesh 422 may be encoded using a base mesh encoder 420, the displacement data 432 may be encoded using a displacement encoder 430, and the attribute data 442 may be encoded using a video encoder 440.

Each encoder generates a respective sub-bitstream based on the mesh data received. For example, the atlas encoder 410 generates an atlas sub-bitstream 414, the base mesh encoder 420 generates a base mesh sub-bitstream 424, the displacement encoder 430 generates a displacement sub-bitstream 434, and the video encoder 440 generates an attribute sub-bitstream 444. As described below, the encoders, such as the base mesh encoder 420 and the displacement encoder 430, may use encode bitstream conformance conditions that are configured to establish, when decoded, the at least one submesh and at least one meshpatch (such as by using at least two bounding boxes) to prevent an overlap of at least two bounding boxes generated based on the geometry data from the at least one meshpatch.

For example, a base mesh, which typically has a smaller number of vertices compared to the original mesh, is created and is quantized and compressed in either a lossy or lossless manner and then encoded as a compressed base mesh sub-bitstream 424. This may include, for example, a static mesh decoder decodes and reconstructs the base mesh, providing a reconstructed base mesh that undergoes one or more levels of subdivision.

For the displacement sub-bitstream 434, a displacement field may be created for each subdivision representing the difference between the original mesh and the subdivided reconstructed base mesh. In inter-coding of a mesh frame, the base mesh is coded by sending vertex motions instead of compressing the base mesh directly. In either case, a displacement field 408 is created. Each displacement of the displacement field 408 may include three components, denoted by x, y, and z. These components may be with respect to a canonical coordinate system or a local coordinate system where x, y, and z represent the displacement in local normal, tangent, and bi-tangent directions. It will be understood that multiple levels of subdivision can be applied, such that multiple subdivided mesh frames are created and a displacement field for each subdivided mesh frame is also created.

The displacement data 432 undergo one or more levels of wavelet transformation to create level of detail (LOD) signals that are scalar quantized. The quantized LOD signals corresponding to the displacement data 432 are coded into a compressed bitstream. For example, the quantized LOD signals may be packed into a 2D image/video using an image packing operation and are compressed losslessly or in a lossy manner by using an image or video encoder to generate the displacement sub-bitstream 434. However, it is possible to use another entropy coder such as an asymmetric numeral systems (ANS) coder or a binary arithmetic entropy coder to code the quantized LOD signals losslessly. There may be other dependencies based on previous samples, across components, and across LODs that may be exploited. The displacements component provides displacement vectors that can be encoded as a geometry video component using any video codec, indicated by the profile or using an SEI message. Alternatively, the profile may indicate that the displacement component is encoded using arithmetic coding.

For the attribute sub-bitstream 444, an inverse quantization operation may be performed on the reconstructed base mesh, which may be combined with the reconstructed LOD signals to reconstruct a deformed mesh. An attribute transfer operation may be performed using the deformed mesh, a static/dynamic mesh, and an attribute map. A point cloud may be a set of 3D points along with attributes such as color, normals, reflectivity, point-size, etc. that represent an object's surface or volume. These attributes are encoded as a compressed attribute sub-bitstream 444. As shown in FIG. 4A, the encoding of the compressed attribute sub-bitstream 444 may also include a padding operation, a color space conversion operation, and a video encoding operation.

In various embodiments, an atlas 405 can also be encoded as the atlas sub-bitstream 414. The atlas component provides information to a decoding or rendering system on how to perform inverse reconstruction. For example, the atlas can provide information on how to perform the subdivision of a base mesh, how to apply the displacement vectors to the subdivided mesh vertices, and how to apply attributes to the base mesh.

The sub-bitstreams (such as the atlas sub-bitstream 414, the base mesh sub-bitstream 424, the displacement sub-bitstream 434, and the attribute sub-bitstream 444) are provided to a multiplexer 450 to generate a compressed bitstream 452 for transmission.

The mesh frame encoding process 400A outputs the compressed bitstream 452 that can, for example, be transmitted to, and decoded by, an electronic device such as the server 104 or the client devices 106-116. The output compressed bitstream can include the compressed atlas bitstream, the compressed base mesh bitstream, the compressed displacements bitstream, and the compressed attribute bitstream as sub-bitstreams of the compressed bitstream.

As shown in FIG. 4B, the decoder 460 receives the compressed bitstream 452 and decodes the compressed bitstream 452 to form a reconstructed base-mesh. The decoder 460 can be represented by, or executed by, the server 200 shown in FIG. 2 or the electronic device 300 shown in FIG. 3.

The 460 may receive the compressed bitstream 452 at a demultiplexer 462, where the compressed bitstream 452 is separated into the sub-bitstreams contained within the compressed bitstream 452. For example, the compressed bitstream 452 may be demultiplexed back into the atlas sub-bitstream 414, the base mesh sub-bitstream 424, the displacement sub-bitstream 434, and the attribute sub-bitstream 444. Each sub-bitstream may be decoded separately. For example, the atlas sub-bitstream 414 may be decoded in an atlas decoder 416 to extract the atlas 412, including the bitstream conformance condition.

Similarly, the base mesh sub-bitstream 424 may be decoded in a base mesh decoder 426 to extract the base mesh 422. For example, the base mesh decoder 426 may take the base sub-mesh bitstream 424 provided by the demultiplexer 462 and reconstructs, from the base mesh sub-bitstream 424, intra base mesh frames using a static mesh decoder. A mesh buffer provides the decoded intra frames to a motion decoder. The motion decoder may also receive inter frame data and uses the intra frame data, inter frame data, and associated tables to reconstruct a base mesh.

The displacement sub-bitstream 434 may be decoded in a displacement decoder 436 to extract the displacement data 432. The decoded displacement data 432 undergoes an image unpacking operation, an inverse quantization operation, and an inverse wavelet transform operation as part of recovering the positions displacements data. Recovering the positions displacements data can also include performing one or more subdivision operations on the mesh frame recovered using the base mesh decoder 426, and extracting positional components (such as x, y, z components or the normal, tangent, bitangent) from the subdivided mesh frames. The base mesh decoder 426 can perform an inverse quantization operation before the subdivision operation is performed.

The attribute sub-bitstream 444 may be decoded in a video decoder 446 to extract the attribute data 442. Additionally, the decoded attribute data 442 may be processed using a color space conversion operation, and the original attributes for the mesh are recovered.

Each of the atlas 412, the base mesh 422, the displacement data 432, and the attribute sub-bitstream 444 may be used to reconstruct the base mesh, such as a reconstructed mesh 466, based on the bitstream conformance conditions. For example, the atlas 412 may be provided to each of a base mesh processing 428, a displacement processing 438, and the reconstructed mesh 466. The base mesh processing 428 may also receive the base mesh 422 to initiate reconstruction of the base mesh based on the atlas 412. For example, the base mesh 422 undergoes subdivision in the base mesh decoder 426. The displacement processing 438 may receive and process the displacement data 432 based on the atlas 412. For example, the received displacement data 432 is decompressed and added to the reconstructed mesh 466 to generate the reconstructed dynamic mesh sequence 468.

Although FIGS. 4A-4B illustrates one example mesh frame encoding process 400A and a frame decoding process 400B, various changes may be made to FIGS. 4A-4B. For example, the number and placement of various components of the mesh frame encoding process 400A, the frame decoding process 400B, or both can vary as needed or desired. In addition, the mesh frame encoding process 400A, the frame decoding process 400B, or both may be used in any other suitable process and is not limited to the specific processes described above. Additionally, as described with respect to FIG. 4A, an atlas bitstream can also be decoded to obtain an atlas that provides information on how to perform inverse reconstruction. For example, the atlas can provide information on how to perform the subdivision of a base mesh, how to apply the displacement vectors to the subdivided mesh vertices, and how to apply attributes to the reconstructed mesh.

As described herein, typically, mesh encoding and decoding operations are highly sequential. For base meshes with a large number of vertices and high frame rates, a mesh codec may have difficulty achieving real-time encoding and decoding. To alleviate this problem, submeshes are used. A base mesh may be divided into multiple submeshes. The submeshes may not be mutually exclusive, that is, some vertices and triangles may be common to different submeshes. It is possible that the submeshes can be encoded and decoded without using any information from other submeshes. This allows multiple instances of a mesh codec to operate in parallel on different submeshes. This also enables functionality to perform decoding of the mesh by decoding only some of the submeshes present in a bitstream. Each decoded submesh may undergo subdivision and then the decoded displacement field is used to refine the position of the subdivided points belonging to that submesh.

V-DMC introduces a new patch type called a meshpatch. A meshpatch may belong to a geometry tile or an attribute tile. In certain embodiments, this disclosure addresses submeshes, meshpatches, and tiles, both geometry and attribute, and explains their relationships.

In certain embodiments, the design intent was that when AspsLodPatchesEnableFlag equals 0, there is a one-to-one correspondence between a submesh and a meshpatch with an ath_id of type P_TILE or I_TILE. In the same manner, there is a one-to-one correspondence between a submesh and a meshpatch with an ath_id of type P_TILE_ATTR or I_TILE_ATTR.

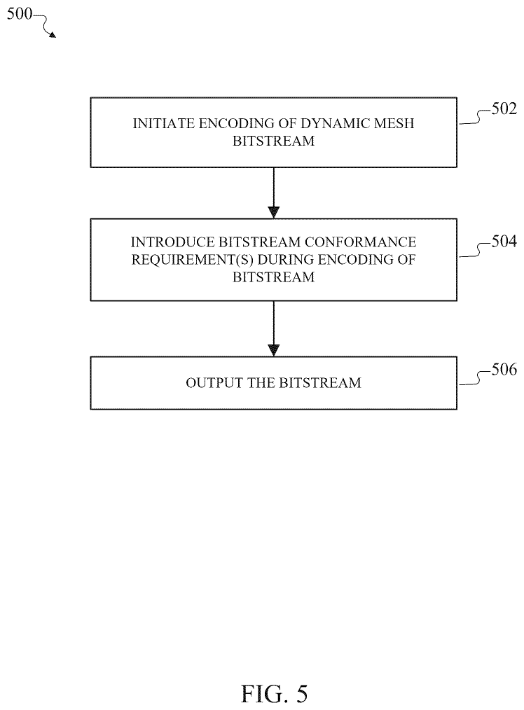

The function GetGeometryPatchIdxInAtlas, for example, retrieves the geometry meshpatch corresponding to a particular submesh and LOD index. However, this approach does not preclude the existence of multiple geometry meshpatches that share the same submesh index (mdu_submesh_idx) and LOD index. Similarly, the function GetAttributePatchIdxInAtlas retrieves the attribute meshpatch corresponding to a particular submesh, without precluding the existence of multiple attribute meshpatches that share the same submesh index (mdu_submesh_idx). In one embodiment, the following bitstream condition is introduced to prohibit this behavior as shown in FIG. 5.

FIG. 5 illustrates an example process 500 for bitstream conformance for related to meshpatches in V-DMC in accordance with this disclosure. In particular, the process 500 may be used to generate non-overlapping bounding boxes during reconstruction or decoding using more effective bitstream conformance conditions, such as the bitstream conformance conditions in the atlas sub-bitstream 414 of FIG. 4. The process 500 illustrated in FIG. 5, however, is for illustration only. FIG. 5 does not limit the scope of this disclosure to any particular implementation of a process for bitstream conformance for reconstruction or decoding of submeshes with non-overlapping bounding boxes. For ease of explanation, the process 500 of FIG. 5 may be described as being performed using the electronic device 300 of FIG. 3. However, the process 500 may be used with any other suitable system and any other suitable electronic device.

As shown in FIG. 5, the electronic device 300 initiates encoding of a dynamic mesh bitstream at step 502, such as described with respect to FIG. 4A. One or more bitstream conformance goals or requirements are introduced during encoding of the bitstream at step 506 that can be recognized by a decoder due to various syntax or signaling elements. In one embodiment, all the compressed bitstreams that conform to a particular dynamic mesh coding standard such as V-DMC or its profile automatically satisfy the conformance condition without any additional syntax or signaling elements. At step 508, the electronic device 300 finishes encoding the bitstream and outputs the bitstream.

As mentioned above, V-DMC allows the base mesh to be split into multiple submeshes. The submeshes can be encoded and decoded independently without using any information from other submeshes. This allows multiple instances of a mesh codec to operate in parallel on different submeshes.

V-DMC also introduces a new patch type called meshpatch. Meshpatch may belong to a geometry tile or an attribute tile. In at least some embodiments, this disclosure relates to submeshes, meshpatches and tiles (geometry as well as attribute) and their relationships.

In at least some embodiments, the design intent was that when AspsLodPatchesEnableFlag is equal to 0, there is a one to one correspondence between a submesh and a meshpatch with ath_id of type P_TILE or I_TILE. Similarly, there is a one to one correspondence between a submesh and a meshpatch with ath_id of type P_TILE_ATTR or I_TILE_ATTR.

The bitstream conformance conditions may be updated to include explicit non-overlap requirements between different meshpatch data units. For example, the bitstream conformance conditions may include a non-overlap condition where two or more meshpatch data units of the at least one submesh do not have the same submesh identification (ID) when the two or more meshpatch data units include: (i) attribute types equal to a predictive inter-frame tile and an intraframe tile and have the same level of detail (LOD) index; or (ii) a predictive inter-frame tile attribute or an interframe tile attribute. As such, preventing an overlap of at least two bounding boxes based on the one or more bitstream conformance conditions includes generating bounding boxes based on meshpatches belonging to separate geometry tiles.

In other words, if two different meshpatch data units have an ath_type equal to P_TILE or I_TILE and the same LOD index, the two different meshpatch data units shall not have the same submesh ID. Similarly, if two different meshpatch data units have ath_type equal to P_TILE_ATTR or I_TILE_ATTR, the two the two different meshpatch data units shall also not have the same submesh ID. Preventing the two different meshpatch data units in each scenario from having the same submesh ID will prevent construction of overlapping bounding boxes based on the meshpatch data units. In other words, when bounding boxes are constructed, the data in the meshpatch data units will be preserved, even if different meshpatch data units have similar attributes or geometries.

These bitstream conformance conditions may be included in meshpatch data unit semantics configured to generate a flag if these conditions occurs. For example, For each meshpatch unit with ath_type equal to P_TILE or I_TILE, syntax elements mdu_2d_pos_x, mdu_2d_pos_y, mdu_2d_size_x_minus1, and mdu_2d_size_y_minus1 are signaled. These are used to derive the bounding box within that tile, corresponding to that meshpatch. The bounding box is specified by the variables TileMeshpatch2dPosX[tileID][p], TileMeshpatch2dPosY[tileID][p], TileMeshpatch2dSizeX[tileID][p], and TileMeshpatch2dSizeY[tileID][p], where tileID is the geometry tile index and p is the meshpatch index.

The bounding boxes corresponding to meshpatches belonging to different geometry tiles are guaranteed to be non-overlapping since the geometry tiles are non-overlapping. However, the bounding boxes corresponding to two such meshpatches belonging to the same tile, each with ath_type equal to P_TILE or I_TILE, should be non-overlapping since these bounding boxes are used to extract displacement data. Otherwise, the overlapping displacement data will be used to reconstruct the submeshes. This violates the concept that it should be possible to reconstruct and process the submeshes independently and also this may lead to loss of some valid displacement data due to overlap.

The general decoding process for meshpatch data units may utilize two meshpatches belonging to a geometry tile with tile ID equal to tileID and meshpatch indices of p and q, respectively. Each meshpatch has ath_type equal to P_TILE or I_TILE. Then, it may be a requirement or objective of atlas bitstream conformance that one of the following conditions is true:

$$TileMeshpatch 2 dPosX [ tileID ] [ p ] + TileMeshPatch 2 dSizeX [ tileID ] [ p ] <= TileMeshpatch 2 dPosX [ tileID ] [ q ]$$

$$TileMeshpatch 2 dPosX [ tileID ] [ q ] + TileMeshPatch 2 dSizeX [ tileID ] [ q ] <= TileMeshpatch 2 dPosX [ tileID ] [ p ]$$

$$TileMeshpatch 2 dPosY [ tileID ] [ p ] + TileMeshPatch 2 dSizeY [ tileID ] [ p ] <= TileMeshpatch 2 dPosY [ tileID ] [ q ]$$

$$TileMeshpatch 2 dPosY [ tileID ] [ q ] + TileMeshPatch 2 dSizeY [ tileID ] [ q ] <= TileMeshpatch 2 dPosY [ tileID ] [ p ]$$

This bitstream conformance condition shall not apply to meshpatches belonging to an unavailable atlas frame, such as in clause 9.2.4.2.2.

In one embodiment of the disclosure, instead of specifying the non-overlap condition in terms of decoded variables, it is equivalently specified in terms of syntax elements as below. This condition is equivalent to the earlier condition only when PatchPackingBlockSize, PatchSizeXQuantizer, and PatchSizeYQuantizer are equal to each other.

Additionally or alternatively, In bitstreams conforming to this version of this document for each pair of meshpatches belonging to a geometry tile, with tile ID equal to tileID and meshpatch indices equal to p and q, respectively, shall fulfill at least one of the following conditions:

$$mdu\_ 2 d\_pos \_x [ tileID ] [ p ] + mdu\_ 2 d\_size \_x \_minus1 [ tileID ] [ p ] + 1 <= mdu\_ 2 d\_pos \_x [ tileID ] [ q ]$$

$$mdu\_ 2 d\_pos \_x [ tileID ] [ q ] + mdu\_ 2 d\_size \_x \_minus1 [ tileID ] [ q ] + 1 <= mdu\_ 2 d\_pos \_x [ tileID ] [ p ]$$

$$mdu\_ 2 d\_pos \_y [ tileID ] [ p ] + mdu\_ 2 d\_size \_y \_minus1 [ tileID ] [ p ] + 1 <= mdu\_ 2 d\_pos \_y [ tileID ] [ q ]$$

$$mdu\_ 2 d\_pos \_y [ tileID ] [ q ] + mdu\_ 2 d\_size \_y \_minus1 [ tileID ] [ q ] + 1 <= mdu\_ 2 d\_pos \_y [ tileID ] [ p ]$$

Additionally or alternatively, a similar bitstream conformance condition on bounding boxes for attribute meshpatches, each with ath_type equal to P_TILE_ATTR or I_TILE_ATTR is introduced. For example, the decoding process for meshpatch data units may consider two meshpatches belonging to an attribute tile with tile ID equal to tileID and meshpatch indices of p and q, respectively. Each meshpatch has the ath_type equal to P_TILE_ATTR or I_TILE_ATTR. Then it may be a requirement or objective of atlas bitstream conformance that one of the following conditions is true:

$$TileMeshpatchAttributes 2 dPosX [ tileID ] [ p ] + TileMeshpatchAttributes 2 dSizeX [ tileID ] [ p ] <= TileMeshpatchAttributes 2 dPosX [ tileID ] [ q ]$$

$$TileMeshpatchAttributes 2 dPosX [ tileID ] [ q ] + TileMeshpatchAttributes 2 dSizeX [ tileID ] [ q ] <= TileMeshpatchAttributes 2 dPosX [ tileID ] [ p ]$$

$$TileMeshpatchAttributes 2 dPosY [ tileID ] [ p ] + TileMeshpatchAttributes 2 dSizeY [ tileID ] [ p ] <= TileMeshpatchAttributes 2 dPosY [ tileID ] [ q ]$$

$$TileMeshpatchAttributes 2 dPosY [ tileID ] [ q ] + TileMeshpatchAttributes 2 dSizeY [ tileID ] [ q ] <= TileMeshpatchAttributes 2 dPosY [ tileID ] [ p ]$$

This bitstream conformance condition shall not apply to meshpatches belonging to an unavailable atlas frame, such as in clause 9.2.4.2.2.

Additionally or alternatively, instead of specifying the non-overlap condition in terms of decoded variables, it is equivalently specified in terms of syntax elements as below. This condition is equivalent to the earlier condition only when PatchPackingBlockSize, PatchSizeXQuantizer, and PatchSizeYQuantizer are equal to each other.

For example, for each pair of meshpatches belonging to an attribute tile, with tile ID equal to tileID and meshpatch indices equal to p and q, respectively, shall fulfill at least one of the following conditions:

$$mdu\_attributes \_ 2 d\_pos \_x [ tileID ] [ p ] + mdu\_attributes2d \_size \_x \_minus1 [ tileID ] [ p ] + 1 <= mdu\_attributes \_ 2 d\_pos \_x [ tileId ] [ q ]$$

$$mdu\_attributes \_ 2 d\_pos \_x [ tileID ] [ q ] + mdu\_attributes \_ 2 d\_size \_x \_minus1 [ tileID ] [ q ] + 1 <= mdu\_attributes \_ 2 d\_pos \_x [ tileId ] [ p ]$$

$$mdu\_attributes \_ 2 d\_pos \_y [ tileID ] [ p ] + mdu\_attributes \_ 2 d\_size \_y \_minus1 [ tileID ] [ p ] + 1 <= mdu\_ 2 d\_pos \_y [ tileId ] [ q ]$$

$$mdu\_attributes \_ 2 d\_pos \_y [ tileID ] [ q ] + mdu\_attributes \_ 2 d\_size \_y \_minus1 [ tileID ] [ q ] + 1 <= mdu\_attributes \_ 2 d\_pos \_y [ tileId ] [ p ]$$

Further, in the DIS version of atlas frame mesh information syntax and semantics, two syntax elements, afmi_use_single_mesh_flag and afmi_num_submeshes_minus2, are used to signal the number of submeshes in the mesh frame. The afmi_use_single_mesh_flag is only used in the signaling and semantics of afmi_num_submeshes_minus2. For example, these two syntax elements may be combined into a single syntax element, afmi_num_submeshes_minus1 as below. This reduces the number of syntax elements and simplifies the specification text for the bitstream conformance conditions.

8.3.6.2.5 Atlas frame mesh information syntax

| | Descriptor |
|---|---|
| atlas_frame_mesh_information( ) { | |
| afmi_use_single_mesh_flag | u(1) |
| if( !afmi_use_single_mesh_flag ) { | |
| afmi_num_submeshes_minus21 | u(8) |
| NumSubMeshes = afmi_num_submeshes_minus2 + 2 | |
| } | |
| else | |
| NumSubMeshes = 1 | |
| afmi_signalled_submesh_id_flag | u(1) |
| if( afve_signalled_submesh_id_flag ) { | |
| afmi_signalled_submesh_id_delta_length | ue(v) |
| for( i = 0; i < NumSubMeshes; i++ ) | |
| afmi_submesh_id[ i ] | u(v) |
| SubmeshIDToIndex[ afmi_submesh_id[ i ] ] = i | |
| SubmeshIndexToID[ i ] = afmi_submesh_id[ i ] | |
| } | |
| } else { | |
| for( i = 0; i < NumSubMeshes; i++ ) { | |
| afmi_submesh_id[ i ] = i | |
| SubmeshIDToIndex[ i ] = i | |
| SubmeshIndexToID[ i ] = i | |
| } | |
| } | |
| } | |

Further, afmi_num_submeshes_minus1 plus 1 specifies the number of submeshes referred by mesh patches in each atlas frame referring to the AFPS. The value of afmi_num_submeshes_minus1 shall be in the range of 0 to 63, inclusive. Additionally, the requirement that when afmi_num_submeshes_minus2 is not present and afmi_use_single_mesh_flag is equal to 1, NumSubMeshes value is inferred to be equal to 1 is removed.

Additionally or alternatively, afmi_num_submeshes_minus1 is signaled as ue(v) instead of u(8). This uses the same number of bits as before when only one submesh is present. Additionally or alternatively, afmi_num_submeshes_minus1 is signalled as u(6) instead of u(8).

Additionally or alternatively, this change is also applied to signaling of the number of submeshes in the base mesh.

Further, base mesh submesh information may be updated. For example, bmsi_num_submeshes_minus1 plus 1 may specify the number of submeshes in each basemesh frame referring to the BMFPS. The value of bmsi_num_submeshes_minus1 shall be in the range of 0 to 63, inclusive. The condition that bmsi_use_single_mesh_flag equal to 1 specifies that there is only one submesh in each basemesh frame referring to the BMFPS may be removed. The condition that bmsi_use_single_mesh_flag equal to 0 specifies that there may be more than one submeshes in each basemesh frame referring to the BMFPS may be removed. Additionally, the condition that, when bmsi_num_submeshes_minus2 is not present and bmsi_use_single_mesh_flag is equal to 1, NumBmeshSubMeshes value is inferred to be equal to 1 may be removed. The updated base mesh submesh information may be displayed as follows:

H.8.3.2.2.2 Basemesh submesh information

| | De- |
|---|---|
| | scrip- |
| | tor |
| bmesh_submesh_information( ) { | |
| bmsi_use_single_mesh_flag | u(1) |
| if(!bmsi_use_single_mesh_flag){ | |
| bmsi_num_submeshes_minus21 | ue(v) |
| NumBmeshSubMeshes = bmsi_num_submeshes_minus2 + | |
| 2 | |
| } | |
| else | |
| NumBmeshSubMeshes = 1 | |
| ... | |
| } | |

Additionally or alternatively, bmsi_num_submeshes_minus1 is signaled as u(6) instead of ue(v). Further, this change is also applied to signaling of the number of submeshes in the tile submesh mapping SEI message. For example, the condition that tmsm_use_single_mesh_flag[i] equal to 1 specifies that there is only one submesh in the tile with index equal to i. tmsm_use_single_mesh_flag[i] equal to 0 specifies that there may be more than one submeshes in the tile with index i may be removed. Additionally, the condition that, when tmsm_num_submeshes_minus2[i] is not present and tmsm_use_single_mesh_flag[i] is equal to 1, NumSubMeshes[i] value is inferred to be equal to 1, may be removed. The updated base mesh submesh information may be displayed as follows:

F2.7 Tile submesh mapping SEI payload syntax

| | De- |
|---|---|
| | scrip- |
| | tor |
| tile submesh_mapping( payloadSize ) { | |
| ... | |
| for( i = 0; i < tmsm_num_tiles_minus1 + 1; i++ ) { | |
| tmsm_tile_id[ i ] | u(v) |
| TileIdxToID[ i ] = tmsm_tile_id[ i ] | |
| tmsm_tile_type_flag[ i ] | u(1) |
| tmsm_use_single_mesh_flag[ i ] | u(1) |
| if( !tmsm_use_single_mesh_flag ) { | |
| tmsm_num_submeshes_minus21[ i ] | u(8) |
| NumSubMeshes[ i ] = tmsm_num_submeshes_min2[ i ] + 2 | |
| else | |
| NumSubMeshes[ i ] = 1 | |
| tmsm_submesh_id_length_minus1[ i ] | ue(v) |
| for( j = 0; j < NumSubMeshes[ i ]; j++ ) { | |
| tmsm_submesh_id[ i ][ j ] | u(v) |
| SubmeshIdxToID[ i ][ j ] = tmsm_submesh_id[ i ][ j ] | |
| } | |
| } | |
| } | |

Additionally or alternatively, tmsm_num_submeshes_minus1[i] may be signaled as u(6) instead of u(8).

Although FIG. 5 illustrates one example process 500 for bitstream conformance related to meshpatches in V-DMC, various changes may be made to FIG. 5. The 500 may be used in any other suitable process and is not limited to the specific process described above. Also, while shown as a series of steps, various steps in FIG. 5 may overlap, occur in parallel, or occur any number of times.

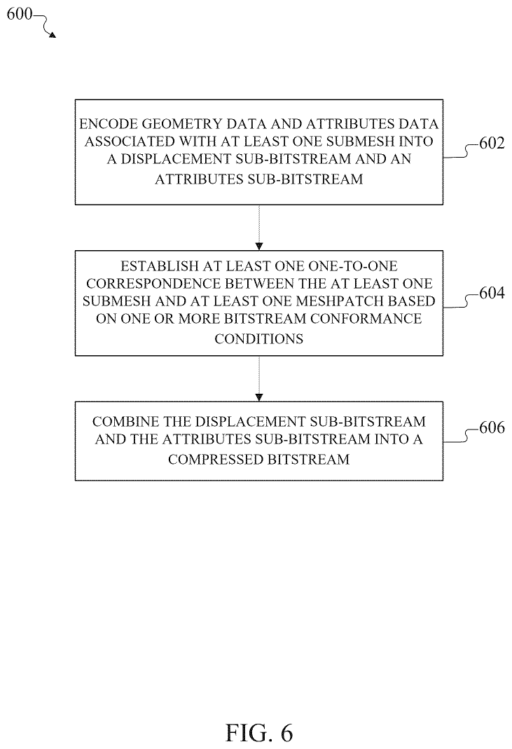

FIG. 6 illustrates an example encoding method 600 using bitstream conformance conditions related to meshpatches in V-DMC in accordance with this disclosure. For ease of explanation, the method 600 of FIG. 6 is described as being performed using the electronic device 300 of FIG. 3. However, the method 600 may be used with any other suitable system and any other suitable electronic device.

As shown in FIG. 6, geometry data and attributes data associated with an individual submesh is encoded at step 602. For example, the mesh frame encoder 402 may receive a input dynamic mesh sequence 404 that is separated into geometry and attribute data. In some embodiments, the geometry data corresponds to displacements created based on subdividing one or more submeshes. The 402 encodes the geometry data and the attributes data associated with the individual submesh into a displacement sub-bitstream 434 and an attributes sub-bitstream 4444, respectively, such as described with respect to FIG. 4A. In various embodiments, bitstream conformance requirements or goals can be imposed, such as described with respect to FIG. 5, such that the geometry data and attributes data associated with the individual submesh are capable of being separated from data corresponding to one or more other submeshes in the displacement sub-bitstream and the attributes sub-bitstream during decoding.

The at least one submesh and at least one meshpatch are established at step 604. For example, the mesh frame encoder 402 may establish the at least one submesh and at least one meshpatch may be based on one or more bitstream conformance conditions configured to prevent an overlap of at least two bounding boxes based on the geometry data. The one or more bitstream conformance conditions may be transmitted as part of the atlas sub-bitstream 414.

At step 606, the electronic device combines the displacement sub-bitstream and the attributes sub-bitstream into a compressed bitstream, as also described with respect to FIG. 4A.

In some embodiments, during the encoding, the mesh frame encoder 402 can signal a bounding box associated with the individual submesh, the bounding box corresponding to two-dimensional (2D) coordinates of at least one of the displacement sub-bitstream and the attributes sub-bitstream, as described with respect to FIG. 5. In particular, the encoder 402 ensures that the displacement data for various meshpatches is placed in non-overlapping regions of the video frame to satisfy the conformance constraint. In various embodiments, the electronic device 300 can form the bounding box to be at least one of (i) in a smallest possible area while still including all 2D positions that contain coded data corresponding to the individual submesh and (ii)non-overlapping with one or more other bounding boxes associated with one or more other submeshes.

The mesh frame encoder 402 may output the compressed bitstream. This output bitstream can also include the compressed base mesh bitstream, and the atlas sub-bitstream described, for example, with respect to FIG. 4A, as well as any of the signaling elements described above. The output bitstream can be transmitted to an external device or to a storage on the electronic device 300.

Although FIG. 6 illustrates one example of an encoding method 600 using bitstream conformance conditions related to meshpatches in V-DMC, various changes may be made to FIG. 6. For example, while shown as a series of steps, various steps in FIG. 6 may overlap, occur in parallel, or occur any number of times.

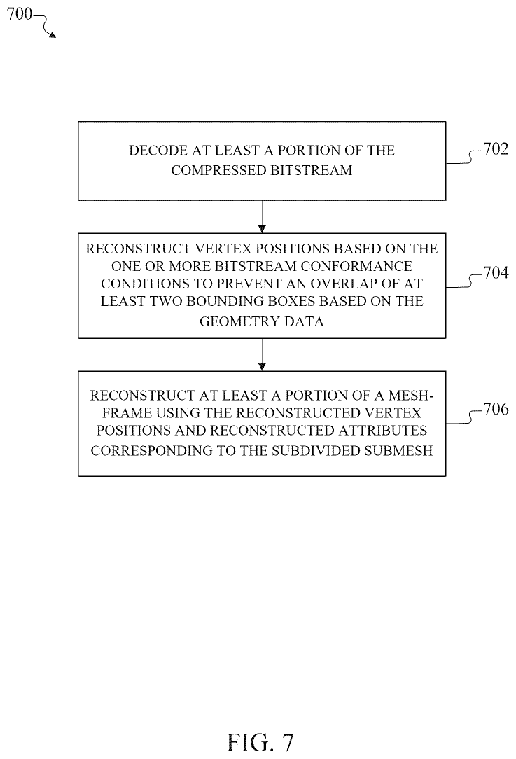

FIG. 7 illustrates an example decoding method 700 using bitstream conformance conditions related to meshpatches in V-DMC in accordance with this disclosure. For ease of explanation, the method 700 of FIG. 7 is described as being performed using the electronic device 300 of FIG. 3. However, the method 700 may be used with any other suitable system and any other suitable electronic device.

As shown in FIG. 7, at step 702. For example, the decoder 460 receives a compressed bitstream having sub-bitstreams including a base mesh sub-bitstream, a displacement sub-bitstream, and an attributes sub-bitstream. In some embodiments, the compressed bitstream can also include an atlas sub-bitstream. The decoder 460 decodes at least a portion of the compressed bitstream, which can include decoding a plurality of submeshes from the base mesh sub-bitstream, decoding geometry data from the displacement sub-bitstream, and decoding attributes data from the attributes sub-bitstream, as also described with respect to FIG. 4B.

In some embodiments, the decoder 460 can decode a bounding box associated with the subdivided submesh signaled by an encoder, where the bounding box corresponds to two-dimensional (2D) coordinates of at least one of the displacement sub-bitstream and the attributes sub-bitstream, as described with respect to FIG. 5. In some embodiments, the bounding box occupies a smallest possible area while still including all 2D positions that contain coded data corresponding to the submesh.

Vertex positions are reconstructed based on the one or more bitstream conformance conditions at step 706. For example, the decoder 460 subdivides a submesh of the plurality of submeshes to generate a subdivided submesh. The vertex positions are used to reconstruct at least a portion of a mesh frame at step 708. For example, the reconstruction portion 464 of the decoder 460 reconstructs at least vertex positions, using the decoded geometry data, and attributes, using the decoded attributes data, of the subdivided submesh independently of decoded data corresponding to one or more other submeshes, as also described with respect to FIG. 5. The decoded geometry data can be from independently decodable units for signaled IDs corresponding to that submesh. This can include the decoder 460 using an inverse wavelet transform on the decoded geometry data corresponding to the submesh to obtain displacements associated with the subdivided submesh independently from the decoded geometry data corresponding to the one or more other submeshes. The decoder 460 may then outputs the decoded content, such as 3D video including a reconstructed mesh-frame. The output decoded content can be transmitted to an external device or to a storage on the electronic device 300, for instance.

Although FIG. 7 illustrates one example of a decoding method 700 using bitstream conformance conditions related to meshpatches in V-DMC, various changes may be made to FIG. 7. For example, while shown as a series of steps, various steps in FIG. 7 may overlap, occur in parallel, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method, comprising:
encoding mesh data associated with at least one submesh into an atlas sub-bitstream, a displacement sub-bitstream, and an attributes sub-bitstream;
establishing the at least one submesh and at least one meshpatch based on one or more bitstream conformance conditions, wherein the one or more bitstream conformance conditions are configured to prevent an overlap of at least two bounding boxes based on the mesh data; and
combining the displacement sub-bitstream and the attributes sub-bitstream into a compressed bitstream.

2. The method of claim 1, wherein the bitstream conformance conditions comprise a non-overlap condition where two or more meshpatch data units of the at least one submesh do not have the same submesh identification (ID) when the two or more meshpatch data units include:
(i) geometry types, and have the same level of detail (LOD) index; or
(ii) attribute types.

3. The method of claim 1, wherein preventing an overlap of at least two bounding boxes based on the one or more bitstream conformance conditions comprise generating bounding boxes based on meshpatches.

4. The method of claim 1, wherein establishing the at least one one-to-one correspondence between the at least one submesh and the at least one meshpatch based on the one or more bitstream conformance conditions further comprises:
combining at least two syntax elements to signal a number of submeshes.

5. The method of claim 4, wherein the at least two syntax elements indicate a single mesh flag and a number of submeshes.

6. The method of claim 4, wherein the at least two syntax elements are combined into a single syntax element.

7. The method of claim 1, wherein the one or more bitstream conformance conditions do not apply to meshpatches belonging to unavailable frames.

8. An apparatus comprising:
a communication interface; and
a processor operably coupled to the communication interface, the processor configured to:
encode mesh data associated with at least one submesh into an atlas sub-bitstream, a displacement sub-bitstream, and an attributes sub-bitstream;
establish the at least one submesh and at least one meshpatch based on one or more bitstream conformance conditions, wherein the one or more bitstream conformance conditions are configured to prevent an overlap of at least two bounding boxes based on the meshdata; and
combine the displacement sub-bitstream and the attributes sub-bitstream into a compressed bitstream.

9. The apparatus of claim 8, wherein the bitstream conformance conditions comprise a non-overlap condition where two or more meshpatch data units of the at least one submesh do not have the same submesh identification (ID) when the two or more meshpatch data units include:
(i) geometry types, and have the same level of detail (LOD) index; or
(ii) attribute types.

10. The apparatus of claim 8, wherein the processor, while preventing an overlap of at least two bounding boxes based on the one or more bitstream conformance conditions, is further configured to generate bounding boxes based on meshpatches.

11. The apparatus of claim 8, wherein the processor, while establishing the at least one one-to-one correspondence between the at least one submesh and the at least one meshpatch based on the one or more bitstream conformance conditions, is further configured to:
combine at least two syntax elements to signal a number of submeshes.

12. The apparatus of claim 11, wherein the at least two syntax elements indicate a single mesh flag and a number of submeshes.

13. The apparatus of claim 11, wherein the at least two syntax elements are combined into a single syntax element.

14. The apparatus of claim 8, wherein the one or more bitstream conformance conditions do not apply to meshpatches belonging to unavailable frames.

15. An apparatus comprising:
a communication interface configured to receive a compressed bitstream having sub-bitstreams including an atlas sub-bitstream, a base mesh sub-bitstream, a displacement sub-bitstream, and an attributes sub-bitstream; and
a processor operably coupled to the communication interface, the processor configured to:
decode at least a portion of the compressed bitstream, wherein the processor is configured to decode at least one submesh and at least one meshpatch from the base mesh sub-bitstream, decode mesh data from the displacement sub-bitstream, and decode attributes data from the attributes sub-bitstream based on one or more bitstream conformance conditions;
reconstruct vertex positions, using the decoded mesh data, and attributes, using the decoded attributes data, based on the one or more bitstream conformance conditions to prevent an overlap of at least two bounding boxes based on the geometry data; and
reconstruct at least a portion of a mesh-frame using the reconstructed vertex positions and reconstructed attributes corresponding to the submesh.

16. The apparatus of claim 15, wherein the bitstream conformance conditions comprise a non-overlap condition where two or more meshpatch data units of the at least one submesh do not have the same submesh identification (ID) when the two or more meshpatch data units include:
(i) geometry types, and have the same level of detail (LOD) index; or
(ii) attribute types.

17. The apparatus of claim 15, wherein the processor, while preventing an overlap of at least two bounding boxes based on the one or more bitstream conformance conditions, is further configured to generate bounding boxes based on meshpatches.

18. The apparatus of claim 15, wherein the processor, while decode at least one submesh and at least one meshpatch, is further configured to:
establish at least one one-to-one correspondence between the at least one submesh and the at least one meshpatch based on the one or more bitstream conformance conditions by combine at least two syntax elements to signal a number of submeshes.

19. The apparatus of claim 18, wherein the at least two syntax elements indicate a single mesh flag and a number of submeshes.

20. The apparatus of claim 18, wherein the at least two syntax elements are combined into a single syntax element.
